(19) United States
(12) Patent Application Publication
(10) Pub. No.: US 2012/0290405 A1
(43) Pub. Date: Nov. 15, 2012

(54) MONETIZING SOCIAL AND CONTENT NETWORKS AND EBOOKS THROUGH REFERENCE LINK DRIVEN ADVERTISING AND REFERENCE PRETARGETING

(76) Inventor: SRIKRISHNA TALLURI, Grand Blanc, MI (US)

(21) Appl. No.: 13/470,253

(22) Filed: May 11, 2012

Related U.S. Application Data
(60) Provisional application No. 61/518,755, filed on May 11, 2011.
(60) Provisional application No. 61/571,119, filed on Jun. 20, 2011.
(60) Provisional application No. 61/572,647, filed on Jul. 19, 2011.

(51) Int. Cl. G06Q 30/02; G06F 21/20

(52) U.S. Cl. 705/14.69; 726/23

(57) ABSTRACT

An advertising system that increases response rates to advertisements on a social network based on the personal interest score of users and the commercial score of clicked links is described. The system is based on the choices made by the user in selecting and clicking on the links that are displayed in his or her timeline on their social presence. The system also generates additional ‘real estate’ where highly pertinent advertisements may be displayed to the user while also presenting a safer user experience by pre-scanning the clicked reference links for malicious code.

### CROSS-REFERENCE TO RELATED APPLICATIONS

This application claims the benefit of priority of U.S. Provisional Patent Application Ser. No. 61/518,755, filed May 11, 2011 and entitled “MONETIZING SOCIAL AND CONTENT NETWORKS AND EBOOKS THROUGH REFERENCE LINK DRIVEN ADVERTISING AND REFERENCE PRETARGETING”, U.S. Provisional Patent Application Ser. No. 61/571,119, filed Jun. 20, 2011 and entitled “REFERENCE LINK DRIVEN ADVERTISING NETWORK” and U.S. Provisional Patent Application Ser. No. 61/572,647, filed Jul. 19, 2011 and entitled “ANALYSIS OF REFERENCE LINKS TO DRIVE INSTREAM ADVERTISING” the subject matter of all of which is hereby incorporated by reference herein.

### BACKGROUND OF THE INVENTION

This invention relates to social interactions and communication, interactive entertainment and education, social networking, information dissemination and advertising systems.

Social and content driven interactive networks such as LinkedIn, Facebook, Twitter, Google+, Pinterest, Tumblr etc. face the issue of how best to monetize the usage of their network. These social networks have the dual responsibility of providing a safe and secure usage experience while continuously evaluating new ways to capitalize on the usage of the very network. Bloggers who make money from ads on their pages or other advertising mechanisms face the same issue of improving the monetization of their content and traffic.

It has become accepted practice on the consumer Internet and any interactive content exchange or messaging system to share content on other web pages or content hosting locations by providing a reference URL (actual or shortened URL) that links to that web page or content.

However, it has been reported that this process is being misused by miscreants to lure unsuspecting users to external links (web pages or other content hosting locations) that contain malicious code, which is then installed on these users' computers, Internet enabled devices etc. Users who post such malicious links on their social network or content network pages (social presence) may not even be aware themselves of the hidden danger in the links. Examples of such malicious code encompass viruses, key loggers, personal data grabbers or surreptitious Internet usage gathering algorithms. All ‘Phishing’ activities come under our definition of malicious code/software, too. Considering the above, the current processes of providing links to external content have critical shortcomings that could expose users who click on the links to malicious software or applications. Then, there is also the social networks' typical organizational fiscal intent or duty to continually improve and find better monetizing mechanisms.

Also, these links serve an important purpose of recommending a product or other content by an individual to his or her friends, followers or other audience (social graph) who access the said individual's presence on the social or content network. Further, the holy grail of advertising has been to identify, attract and capture prospects/customers who have expressed an interest in or need for specific products or a need for purchasing certain items—ideally before these prospects/customers just enter the buying cycle.

Interestingly, users have been implicitly expressing their intent through the sharing behavior mentioned above and this is not being captured and/or being effectively processed by social and content networks. If this user behavior is properly harnessed, social and content networks would go a long way in addressing their monetizing goals while showing more relevant ads to users and presenting a vastly improved response rate to advertisers.

Hence, it is the object of the present invention to overcome the abovementioned problems and create a novel, improved and safer user experience while enabling the social and content networks to efficiently monetize their user base and provide a better response rate to their advertisers.

### SUMMARY OF THE INVENTION

Accordingly, it is an object of the present invention to protect users on social and content networks from malicious links on social and content networks.

It is another object of the present invention to capture interest and intent of users from their posting, click through and mouse over behavior on social and content networks.

It is yet another object of the present invention to serve highly targeted advertising units to users on social and content networks.

It is still yet another object of the present invention to provide a better response rate to advertisers on social and content networks.

It is still yet another object of the present invention to provide an efficient monetizing mechanism for the social and content networks themselves.

It is still yet another object of the present invention to provide a targeted advertising mechanism on ebooks.

### BRIEF DESCRIPTION OF SEVERAL VIEWS OF THE DRAWING

FIG. 1 is a block diagram of a first embodiment illustrating the reference link resolution and malicious link scanning process in accordance with the present invention.

FIG. 2 is a block diagram of illustrating a mechanism for calculating the malicious link score.

FIG. 3 is a block diagram of a second embodiment illustrating the reference link driven advertising and pre-targeting process in accordance with the present invention.

FIG. 4 is a block diagram of a third embodiment illustrating the reference link driven advertising and pre-targeting process in accordance with the present invention.

### DETAILED DESCRIPTION OF THE INVENTION

The present invention is described below using three illustrative embodiments. Note: the phrases social network and content network are used interchangeably in the description.

### Illustrative Embodiment 1

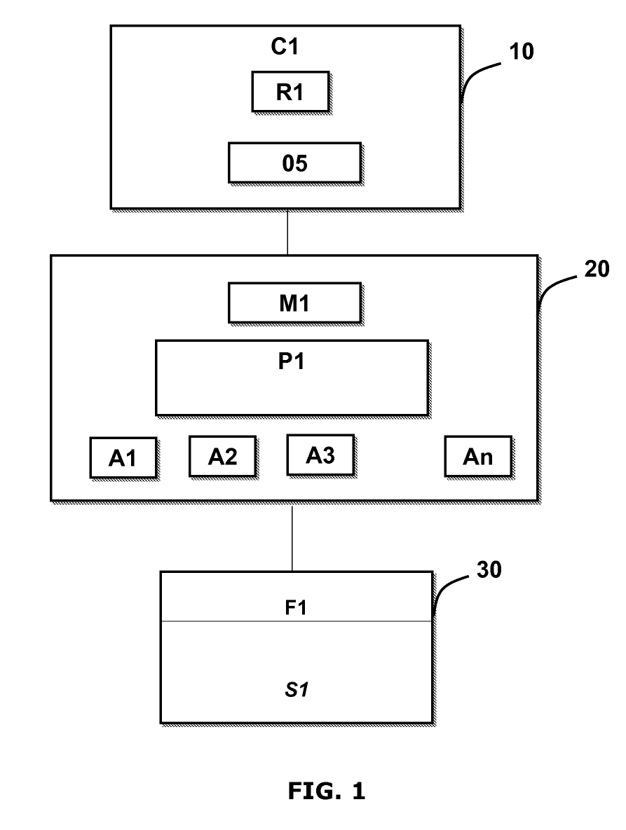

In the first illustrative embodiment of the present invention depicted in FIG. 1, an advertising network 05 displays advertisements on a content network 10. A content preview stage 20 and a source display step 30 also exist. On the content network 10, users may write notes, comments, blogs, responses etc. of any sort, upload or link to images, videos, documents etc. Content on the content network 10 is represented by C1. This content C1 may contain a reference R1 to a web page or other Internet based web content. It is assumed that the content C1 and the reference R1 are generated or posted by a user on the content network on his/her social presence.

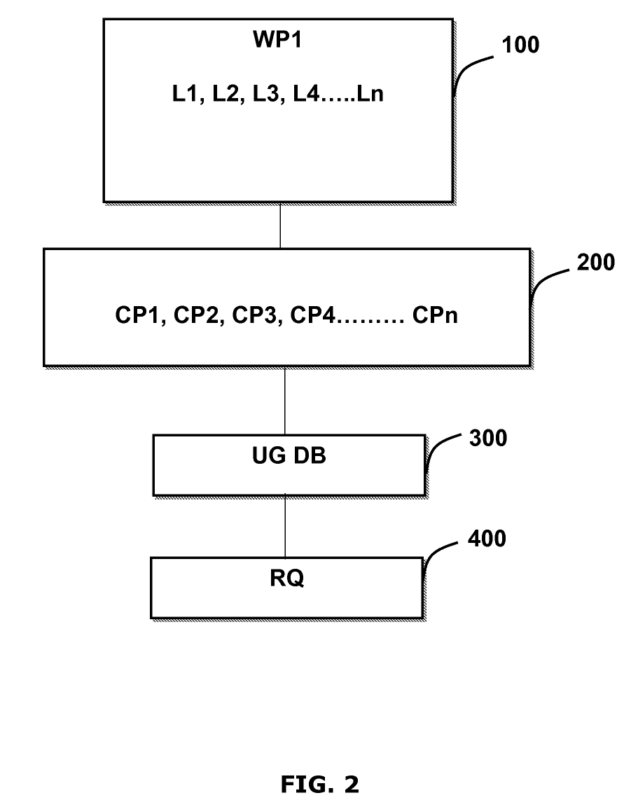

When any user clicks on R1, an intermediary content cleansing and preview stage 20 is presented to that user. This stage may contain a message M1 from the content generation network describing the reason for this data cleansing and preview step and suggestions/remarks/cautions for the user as he proceeds further. M1 may also contain additional information such as the potential/estimated chances of malicious content on the actual source page (described in FIG. 2). This may be displayed as a number, a confidence bound, color coded bar etc.

FIG. 2 shows how a malicious score may be calculated for R1. R1 resolves to WP1 in step 100. WP1 may be a webpage or other content. Here the content on WP1 is analyzed for malicious code by checking the content against known signatures and other identifiers of malicious code available with prominent anti-virus and malicious scanning networks. Then the child level links, if any, on WP1 depicted by L1, L2 . . . Ln are all resolved to their corresponding content shown by CP1, CP2 . . . CPn in step 200 and are scanned and parsed onto the malicious code scanning server. Both the click stream and the actual content for each link are checked for malicious code. Each of the links is checked against a ‘user generated malicious links database’ UGDB in step 300. The UGDB is a database of malicious sites reported by users from their experience. In step 400, previous history of the specific user posting malicious links is taken into consideration. A weighted score for each of the above steps in used to come up with the malicious link score, a confidence bound or a color coded symbol conveying the risk of malicious code on those links. This may be included in M1 in FIG. 1. Alternately, it may also be displayed next to R1 on 10.

Also, M1 may be displayed in a specific section or spread over multiple areas of the display page. P1 displays a cleansed image of the actual source. Note that it is displayed as an image and not in source format. This image may be a thumbnail sized display, a small icon or a scrollable display. The thumbnail image may expanded to a full sized image based on a user action such as a mouse click or (finger) tap. Alternately, the malicious content on the actual source may be sanitized or removed and the cleansed content presented to the user in P1.

The advertising network 05 presents different forms of advertisements A1, A2, A3 . . . An to the users on preview stage 20. These advertisements may be relevant to the user based on the nature of the content in P1 or other reasons such as location, subject categorization, news organization that provided the content, previous behavior on the content network etc. When the user clicks on P1, the user is taken to the display stage 30 where the referred, actual source is presented to the user. The display may further be divided into two or more frames or display sections. These divisions may or may not be visible to the naked eye. For instance, if the display is divided into two frames—the top frame is represented by F1 in the embodiment and the actual referred source represented by S1.

F1 may contain some content from C1 or notes by the first or other users or a back button or a link that takes the user back to C1 etc. This frame may also contain certain advertisements from 05 or other content from/by content network 10 or other third parties. On the other frame S1 in the embodiment, notes or highlights that were entered by the first or other users OR advertisements by advertising network 05 or other content from/by content network 10 or third parties may be displayed. When the user reaches the intermediary content cleansing and preview stage 20, a cookie or other tagging/tracking mechanism is placed on the user's computer or Internet enabled device. This may be placed by the advertising network 05, by C1 or even a third party but with sufficient information and access rights to be read by 05, C1 or the said third party at a later time. This information (cookies, tags, identifier, tracking mechanism etc.) would be used by the advertising network 05 for re-targeting, remarketing or other purposes.

This embodiment presents several advantages. At the very basic level, the users are protected from malicious links and/or advised about the potential threats on the source page based on a malicious link score in M1—in advance. The content network now has additional ‘real estate’ to display ads and monetize usage of their network and the advertising network can now place cookies or tags to monitor users for re-targeting/remarketing of interested products, services, content etc. to these users. Another advantage of this system is that it enables ‘pre-targeting’ i.e. the ads on 20 can be tailored based on the content in P1. For instance, if the content in P1 relates to a review of a new laptop or camera from a specific manufacturer that would be available in stores shortly, this information may now be read and ads displayed (on 20) from other competitors of such a product (laptop, camera etc.). These advertisers may be willing to pay a premium to advertise to such users (potential customers)—as they would be reaching out to a potential customer who has expressed interest in products similar to theirs but has not bought one yet.

Further, an ‘Ad premium score’ can be calculated by the system based on the commercial potential of the content in P1 plus the previous exhibited personal interest of the user who just clicked on R1. A high ‘Ad premium score’ would indicate that the user is more likely to purchase the product, content or service of the kind mentioned in R1. This information could be used by 05 or 10 to charge a premium from advertisers to display their content on 20, 30 or when the user goes back again to 10. For instance, a table of important personal interests (basketball, tennis, pizza, comedy movies etc.) that could be served by advertisements is created and used by 05 or 10. All these personal interests are assigned a base value for each user when they sign up on the content network. As they post articles or contribute content that may be categorized into these personal interests, the corresponding base value goes up. For instance for every article posted by the user on basketball, the base value increases by 2 points and for every click on another article on basketball the value may go up by 1 point. For the content in R1, the commercial value could be determined based on whether or not it is a merchant site where purchases could be made or based on text, entity and semantic analysis of whether there is content being discussed (product reviews) is something that can be purchased. In this example, if there is a discussion on basketball shoes in R1 and the personal interest score for the individual is high for basketball the ‘Ad premium’ score would be high. The two components could be weighed in different ways, but the net result is that the content network 10 or advertising network 05 could charge a premium from advertisers for displaying their ads to the said user.

### Illustrative Embodiment 2

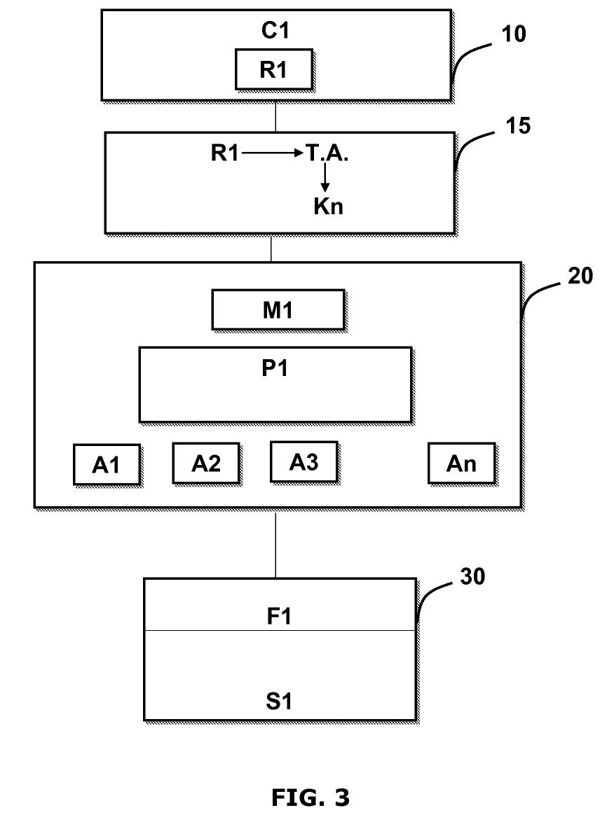

In this embodiment of the present invention depicted in FIG. 3, advertisements and other revenue generating units (RGUs) are placed on a content network based on the reference links submitted/shared by users on the content network. An advertising and RGU presentation network 05 displays advertisements and other RGUs on a content network 10. A semantic analysis stage 15, a content preview stage 20 and a source display step 30 also exist.

On the content network 10, users may write notes, comments, blogs, responses etc. of any sort, upload or link to images, videos, documents etc. Content on the content network 10 is represented by C1. This content C1 may contain a reference link R1 to a file or a web page or other Internet based web content.

The reference link R1 is sent to a semantic analysis engine (T.A.) in stage 15 that parses the content and provides keywords to describe the content on R1. The actual core content of R1 could be scraped free of advertisements and other messages and sent to the semantic analysis engine or the entire webpage/source content that comprises R1 could be sent potentially with additional contextual information. Upon performing a semantic analysis, keywords are assigned to R1. For instance, if reference link R1 contains information about a basketball game or basketball shoes, the semantic analysis engine may return keywords (Kn) such as: basketball, footwear, basketball shoes, sports equipment etc. If additional contextual information is provided to the semantic analysis engine, such as the user who is accessing R1 is a resident of a suburb of Chicago, this would be factored in and the keywords Kn could be expanded to include Chicago, Chicago Bulls etc. This entire process could be done in the background in real-time or with a time lag.

When any user reads C1 and clicks on R1, an intermediary content cleansing and preview stage 20 is presented to that user. This stage may contain a message M1 from the content generation network describing the reason for this data cleansing and preview step and suggestions/remarks/cautions for the user as he proceeds further. M1 may also contain additional information such as the results of an analysis of malicious content on the actual source page such as a malicious score. Also, M1 may be displayed in a specific section or spread over multiple areas of the display page. P1 displays a cleansed image of the actual source. This may be a thumbnail sized display, a small icon or a scrollable display. The thumbnail image may expand to a bigger image based on a user action such as a mouse over, a mouse click or (finger) tap. Alternately, the malicious content on the actual source may be sanitized or removed before the source is presented to the user in P1.

The advertising and RGU presentation network 05 presents different forms of advertisements A1, A2, A3 . . . An and/or RGUs R1, R2, R3 . . . Rn to the users on preview stage 20. These advertisements or RGUs may be relevant to the user based on the nature of the content in P1, based on the results of semantic analysis in stage 15 or other reasons such as location, subject categorization, news organization that provided the content, information from the user's social profile, past user behavior, personal interest score etc. When the user clicks on P1 or after a specific amount of time has passed, the user is taken to the display stage 30 where the referred, actual source is presented to the user. The display stage 30 may further be divided into two or more frames or display sections. These divisions may or may not be visible to the naked eye. For instance, if the display is divided into two frames—the top frame is represented by F1 in the embodiment and the actual referred source represented by S1.

F1 may contain some content from C1 or notes by the first or other users or a back button or a link that takes the user back to C1 etc. This frame may also contain certain advertisements and/or RGUs from 05 or other content from/by content network 10 or other third parties. On the other frame S1 in the embodiment, notes or highlights that were entered by the first or other users OR advertisements and/or RGUs by advertising network 05 or other content from/by content network 10 or third parties may be displayed.

When the user reaches the intermediary content cleansing and preview stage 20, a cookie or other tagging/tracking mechanism is placed on the user's computer or Internet enabled device. This may be placed by the advertising network and RGU presentation network 05, by C1 or even a third party but with sufficient information and access rights to be read by 05, C1 or the said third party at a later time. This information (cookies, tags, tracking mechanism etc.) may contain information/keywords generated by the semantic analysis engine mentioned above that could be used by the 05 for contextual advertising, affiliate marketing, re-targeting, remarketing or other purposes. Note: the generation of an ‘Ad premium score’ described in the previous embodiment is applicable here, too.

In another embodiment of the present invention, the source content is displayed in step 20 which serves both as a prescreening, previewing and viewing stage. Also, the advertising network 05 may be completely independent from 10 and may be available only on 20. In other words, the advertising network, the preview and cleansing stage and subsequent steps including revenue sharing may be offered by a party that is completely external to the content network 10 and its partnering advertising networks.

### Illustrative Embodiment 3

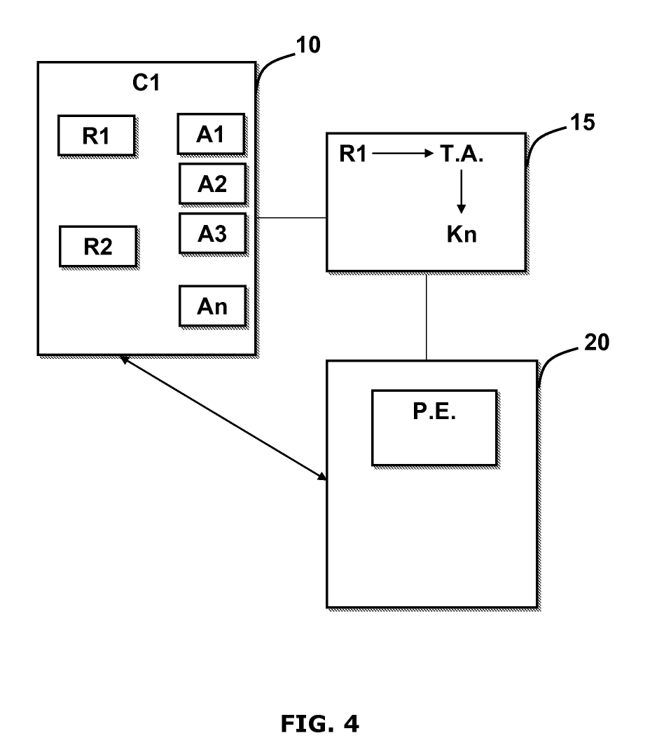

In another embodiment of the present invention depicted in FIG. 4, advertising units and other revenue generating units (RGUs) are placed on a social network 10 based on the reference links submitted/shared by users on the social network. An advertising and RGU presentation network 05 displays advertisements and other RGUs on the social network 10 based on the results of a text and semantic analysis step 15 and a prioritization step 20.

On the social network 10, users may write notes, comments, entire blogs, responses etc. of any sort, upload or link to images, videos, documents etc. Content on 10 is represented by C1. This content C1 may contain one or more reference links R1, R2 etc. to a file or a web page or other Internet based web content.

The reference links R1 (for example) are sent to a text and semantic analysis engine (T.A.) in stage 15. This engine performs all types of text analysis including word frequency, entity extraction and higher order semantic and contextual analysis. As the content is typically from external sites or locations outside the social network, the first step in this stage is to obtain the content on the reference link in order to perform a textual analysis or a semantic analysis. This is achieved through implementing the following, technical steps:

1.1 Presentation/UI Layer:
User logs-in into Social Network using his/her credentials.
He/She updates status information by entering external URLs with or without additional description.
Updated status information is automatically distributed/presented to user's Social Network—appearing in friends' newfeeds.
UI service calls Social Network service layer by sending users' identity and updated status information.

1.2 Service & Data Layer:
Social Network service validates user identity.
Calls data layer for saving updated status information into database.
Service layer calls current invention Service by sending newly generated request ID, user identity and his/her status text.

1.3 Current Invention Service:
Login service authenticates user credentials
Current Invention Service starts processing the User status text
It parses the text and extracts all URLs from it
It calls URL Service by passing all extracted URLs and User credentials
URL Service: URL Service invokes below respective services based on content type of each URL

Image Service:

This service downloads images and stores into current invention's file servers
Converts HTML web page into an image and stores into current invention's file servers

HTML Service:
This service downloads HTML content and stores into current invention's file servers.

It also extracts HTML entities like Images, CSS, Audio & Video URLs from HTML content and invokes URL service and replace original URLs with current invention's URLs.

Audio & Video Service:

This service downloads Audio & Video files and stores into current invention file servers.

PDF/XPS/Proprietary File Service:

This service downloads PDFs, XPS files and other Proprietary File formats and other stores into current invention file servers.

Identity Generator Service:

This service generates unique identifiers which will be used in Short URLs.
Once the Archival process is completed, URL Service replaces all URLs in status information text with current invention Short URLs

URL service calls current invention service by sending Request ID,

User ID, Updated Profile Text
Current Invention Service calls Social Network service by passing

Request ID, User ID and updated profile text.
Current Invention service calls data layer to update user's profile into database.

1.4 Presentation/UI Layer:

When user visits and accesses any of the links inside status information text, those links (short URLs) will redirect the user to current invention server and shows the web page in an image format along with anti-virus results of the original site.

Similarly, when users access their newsfeed containing the links (above) posted by friends, the short URLs will redirect the user to current invention server, which shows the web page in an image format along with anti-virus results of the original site.

When user places mouse over any of the short URLs either inside the status information page or the same short URLs on their corresponding newsfeeds, current invention's browser plug-in will show instant preview of the URL in a small pop-up window inside Social Network site.

Once the content pointed by the URLs is obtained as described above, a text and semantic analysis engine (T.A.) parses the content and matches certain keywords with a pre-existing list of products and services in the database. In addition, the T.A. does a semantic analysis of the content. Based on these two steps, T.A. provides keywords to describe the content in R1 (in the current example).

The actual core content of R1 could be scraped free of advertisements and other messages and sent to the text and semantic analysis engine or the entire webpage/source content that comprises R1 could be sent potentially with additional contextual information. Upon performing the text and semantic analysis, keywords are assigned to R1. For instance, if reference link R1 contains information about a basketball game or basketball shoes, T.A. may return keywords (Kn) such as: basketball, footwear, basketball shoes, sports equipment etc. If additional contextual information is provided to the semantic analysis engine, such as the user who is accessing R1 is a resident of a suburb of Chicago, this would be factored in and the keywords Kn could be expanded to include Chicago, Chicago Bulls etc. This entire process could be done in the background in real-time or with a time lag. All this is achieved in step 15.

In addition to the T.A. step, user behavior such as clicking on a specific reference link R1, R2 etc., time spent reviewing a specific link, geographic location of the user etc. is analyzed by a performance prioritization engine P.E., which would determine which keywords presented by T.A. should be given higher priority and works with the advertising and RGU presentation network 05 to present relevant advertisement units and RGUs (A1, A2, A3 . . . An and/or RGUs R1, R2, R3 . . . Rn) to users on social network 10. These ads and RGU may be placed directly within the stream (or feed) or on the page which contains the stream or on other pages of the Social Network.

While determining the priority of the keywords and advertisement units and RGUs, P.E. may also take into account the nature of the content that makes up C1 (including newsfeed, status information and profile information), subject categorization, news organization that provided the content, information from the user's social profile, current news headlines etc.

On big advantage of this system in all embodiments is that it enables ‘pre-targeting’ i.e. the ads on 10 can be tailored based on the content in the links in C1's feed. For instance, if the content in R1 relates to a review of a new laptop or camera from a specific manufacturer that would be available in stores shortly, this information may now be read and ads displayed (on 10) from other competitors of such a product (laptop, camera etc.). These advertisers may be willing to pay a premium or preferred advertiser fees to the content network 10 or to 05 to advertise to such users (potential customers)—as they would be reaching out to a potential customer whose newsfeed or status information conveys either a recommendation or interest in products similar to theirs but has not bought one yet i.e. customers who are just entering the buying cycle.

Another monetizing method for the content network 10 is to charge opt-out fees from retailers to prevent the display of other ads and RGUs on 10 if their content is referred through R1. For instance, a user on content network 10 is sharing a link to a page about basketball shoes (R1) available at a leading retailer. This is displayed to all his friends on the Social Network. According to the above embodiment, other ads and RGUs (such as deals) would be presented on 10 to the said user as well as his/her friends. These may entice any of the users to follow one of these ads or RGUs and make a purchase from a different retailer or retailers. If the first retailer signs up as a preferred vendor, perhaps, by paying a fee or entering into some kind of revenue sharing agreement with content network 10—then, competing ads and RGUs would not be shown to the users on 10. In addition, the ‘Ad premium score’ could be used to sell ‘preferred vendor’ status to retailers/advertisers wherein, if the ‘Ad premium score’ is above a certain number for a keyword like pizza—then the only the Ads from a specific advertiser are displayed for a certain amount of time on 10. Other methods and advantages of the ‘Ad premium score’ mentioned in the first embodiment are applicable here, too.

This embodiment presents several advantages. Last minute or one time deals that are being offered by retails that the user may not be aware of may be presented by 05 based on R1. The advertising network can now place more relevant contextual ads.

Another feature of the present invention offers the advertising network 05 or the content network 10 the ability to provide an incentive to users who post content such as C1 by sharing advertising revenue from the links that they put up on—as mentioned in the embodiment. This revenue share could be in the form of credits/points, money or other such instruments that are of use to the user and could be redeemed at a specific online retailer or through a specific payment processor. As an example, the advertising network could offer credits to users on content network 10—where the credits may be redeemed when the users make a purchase at a specific online retailer or by using a specific payment processing service. This would present an additional benefit to the said online retailer (who would get an additional number of customers making purchases using their credits) or said payment processor (who would get additional revenues through transaction fees when the users make purchases using that payment processor). Also, such customers may spend more than their credits and actually add to the revenues of the said online retailer or said payment processor.

Some of the features mentioned in one of the three embodiments have not been repeated in the other two to avoid duplication and for ease of reading, but can be incorporated as necessary.

These embodiments present several advantages. At the very basic level, the users are protected from malicious links and/or advised about the potential threats on the referred source page, in advance. Last minute or one time deals that are being offered by retailers that the user may not be aware of may be presented by 05 based on R1. The content network now has additional ‘real estate’ to display ads and monetize usage of their network and the advertising network can now place contextual ads and also place cookies or tags to monitor users for re-targeting/remarketing of interested products, services, content etc. to these users. Further, all the above scenarios are applicable to blogs, newspapers and other content sites such as news networks.

In another embodiment of the present invention, a user may write an article that may or may not be published (offline or online). At a later stage these articles may become available as an ebook on an ebook reader. When the article is made available on the ebook, the content of the referred sources (in the article) may be made accessible from the ebook using a similar mechanism as described in the above embodiments.

In another feature of this embodiment, all the sources of the links (references, citations, bibliography etc.) in the said article would also be made available on the ebook itself.

In the foregoing specification, the invention has been described with reference to illustrative embodiments thereof. However, it will be evident that various modifications and changes may be made thereto without departing from the broader spirit and scope of the invention. The specification and drawings are, accordingly, to be regarded in an illustrative rather than a restrictive sense. Therefore, it is the object of the appended claims to cover all such modifications and changes as come within the true spirit and scope of the invention.

What is claimed is:

1. A system to prevent malicious software infections on a social network where reference links clicked by users are preprocessed and displayed to users through an intermediary step along with a malicious link score.

2. A system of claim 1 where all links are scanned by checking the click stream and checking against a malicious signature database.

3. A system to monetize social networks by analyzing reference links clicked through by users to generate a personal interest score that is combined with a commercial score based on the value of the clicked link and presenting a unified score to obtain higher advertising revenue.
